(19) United States
(12) Patent Application Publication
(10) Pub. No.: US 2012/0024648 A1
(43) Pub. Date: Feb. 2, 2012

(54) PORTABLE DEVICE

(75) Inventors: TZU-YUAN LIU, Tu-Cheng (TW); HSIN-YUNG YANG, Tu-Cheng (TW); CHING-MIN LIN, Tu-Cheng (TW)

(73) Assignee: CHI MEI COMMUNICATION SYSTEMS, INC., Tu-Cheng City (TW)

(21) Appl. No.: 12/910,936

(22) Filed: Oct. 25, 2010

(30) Foreign Application Priority Data
Jul. 28, 2010 (TW) 99124846

(51) Int. Cl. F16F 15/28

(52) U.S. Cl. 188/378

(57) ABSTRACT

A portable device includes a curved base housing a motion sensor, a pendulum, and a motor. The pendulum slides inside the curved base in response to the tilting of the portable device to prevent the portable device from falling over. The motor may generate a torque to tilt the portable device. The motion sensor may detect a tilt angle of the portable device.

### BACKGROUND

1. Technical Field

The present disclosure relates to a portable device.

2. Description of Related Art

Portable devices such as mobile phones or personal digital assistants (PDAs) may use a device mount to stand up straight. However, such portable device often cannot stand up straight without being placed on the device mount.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a perspective view of an exemplary embodiment of a portable device.

FIG. 2 is an exploded perspective view of the portable device of FIG. 1.

FIG. 3 is a cross-sectional view along line III-III of the portable device of FIG. 1.

FIG. 4 is a schematic view of the portable device of FIG. 3 tilted backward.

FIG. 5 is a schematic view of the portable device of FIG. 3 tilted forward.

### DETAILED DESCRIPTION

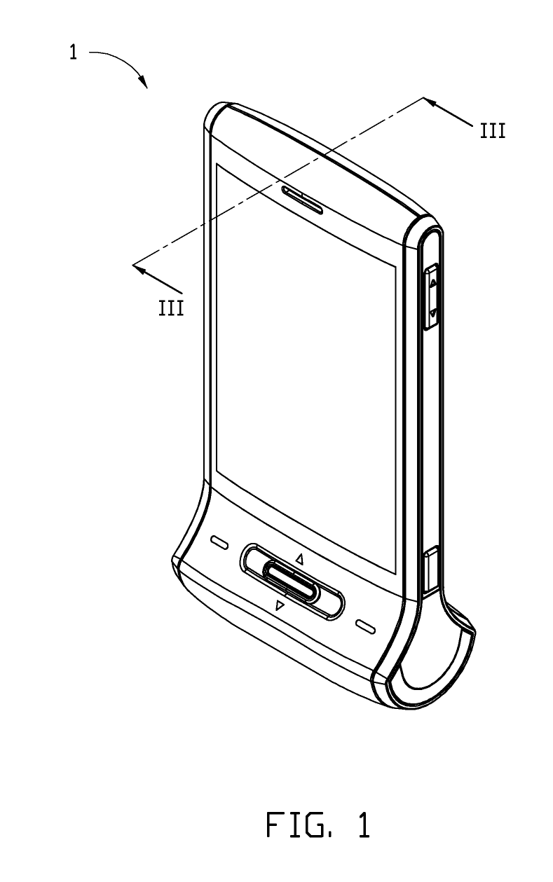

FIG. 1 is a perspective view of one embodiment of a portable device 1. The portable device 1 may be a mobile phone or a personal digital assistant (PDA), for example. In the exemplary embodiment, the portable device 1 is a mobile phone.

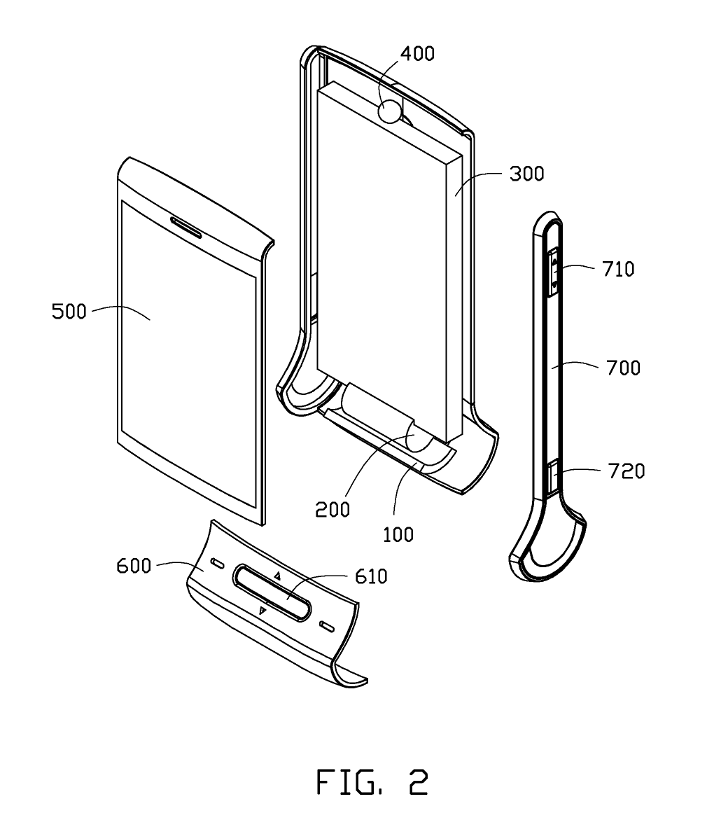

FIG. 2 is an exploded perspective view of the portable device of FIG. 1. The portable device 1 includes a display panel 300, a motion sensor 400, a panel rim 500, and a curved base 600. The curved base 600 houses a pendulum 100 and a motor 200. The pendulum 100 is configured to slide inside the curved base 600 in response to the tilting of the portable device 1 to prevent the portable device 1 from falling over. The motor 200 may be installed above the pendulum 100. The motor 200 may be a stepper motor or a servo motor, for example. The motion sensor 400 may be installed near the top of the portable device 1. In the exemplary embodiment, the motion sensor 400 may be an accelerometer. The panel rim 500 protects the display panel 300.

A navigation key 610 may be installed on the curved base 600. The portable device 1 further includes a sideplate 700. A first control key 710 and a second control key 720 may be installed on the sideplate 700. In the exemplary embodiment, the first control key 710 may adjust the volume generated from the portable device 1, and the second control key 720 may control a camera function of the portable device 1.

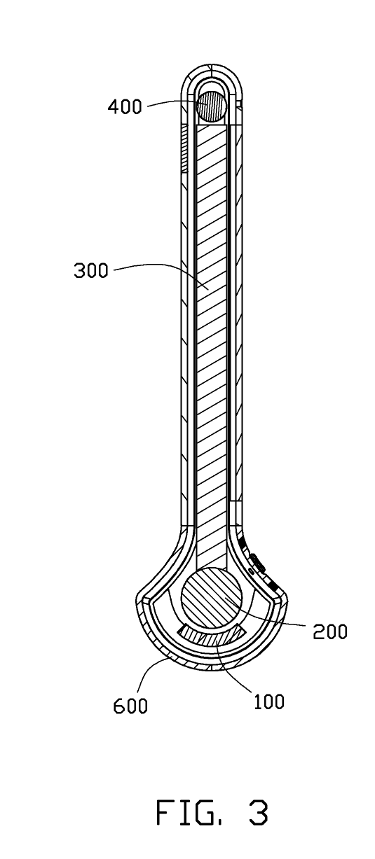

FIG. 3 is a cross-sectional view along line III-III of the portable device 1 of FIG. 1. The portable device 1 stands in an upright position when no force is applied to tilt the portable device 1. The pendulum 100 is curved. In the exemplary, the pendulum 100 is a curved permanent magnet. A curved track (not marked) is defined inside the curved base 600. The pendulum 100 may slide along the curved track inside the curved base 600 when the portable device 1 is tilted back and forward. As a result, the pendulum 100 maintains the center of gravity of the portable device 1 in a position to prevent the portable device 1 from falling over.

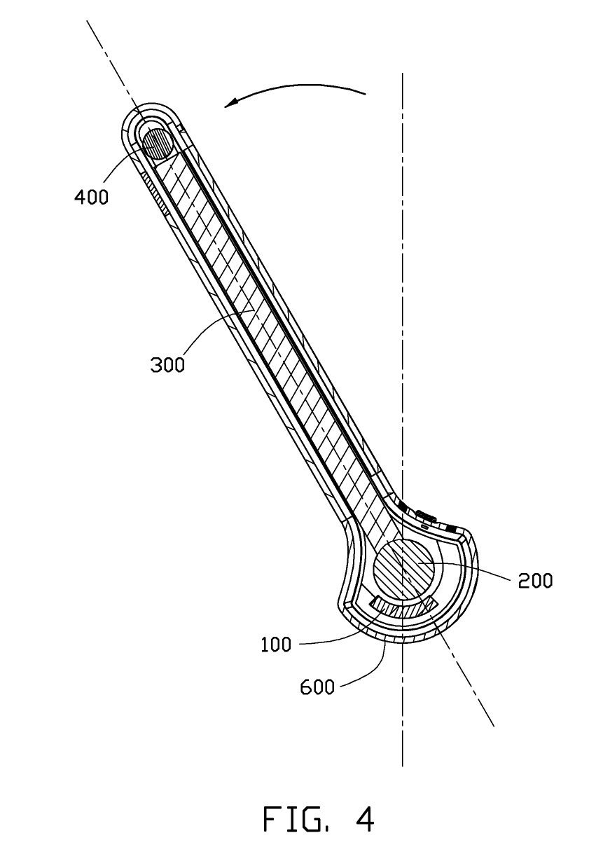

FIG. 4 is a schematic view of the portable device 1 of FIG. 3 tilted backward. The portable device 1 is tilted backward by an external force. The pendulum 100 slides backward to prevent the portable device 1 from falling over when the portable device 1 is tilted backward.

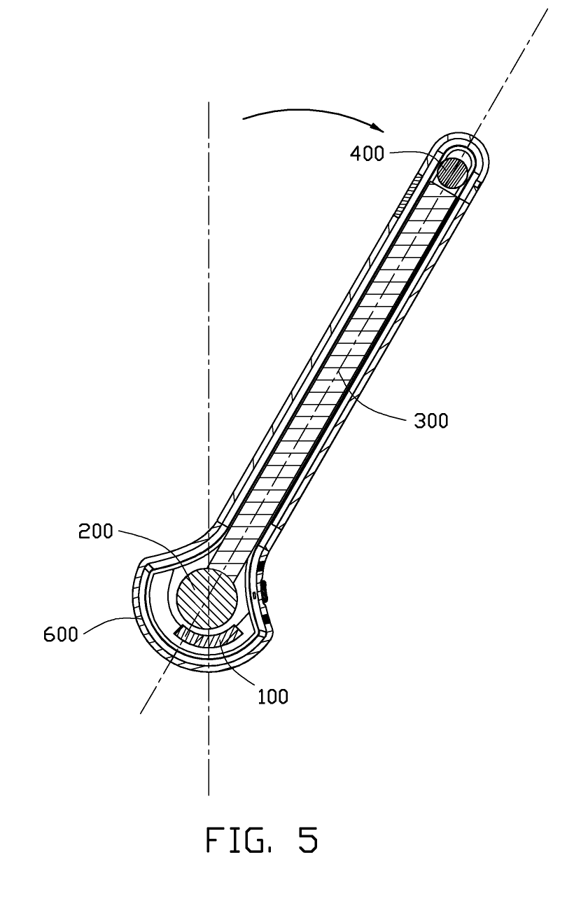

FIG. 5 is a schematic view of the portable device 1 of FIG. 3 tilted forward. The portable device 1 is tilted forward by an external force. The pendulum 100 slides forward to prevent the portable device 1 from falling over when the portable device 1 is tilted forward.

The portable device 1 may further automatically tilt to a designated angle to provide interest. For example, the portable device 1 may tilt backward when receiving an incoming phone call, and tilt forward when receiving a short message service (SMS). In the exemplary embodiment, an application installed in the portable device 1 may control the motor 200 to provide a torque to tilt the portable device 1. The motion sensor 400 may detect a tilt angle of the portable device 1 during tilting. When the application determines the tilt angle matches the designated angle, the application may control the motor 200 to keep the portable device 1 tilted by the designated angle.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A portable device, comprising:
a curved base housing a pendulum; and
wherein the pendulum slides inside the curved base in response to the tilting of the portable device to prevent the portable device from falling over.

2. The portable device of claim 1, wherein the pendulum is curved.

3. The portable device of claim 2, wherein the pendulum is a permanent magnet.

4. A portable device, comprising:
a curved base housing a pendulum and a motor; and
a motion sensor;
wherein the pendulum slides inside the curved base in response to the tilting of the portable device to prevent the portable device from falling over;
wherein the motor generates a torque to tilt the portable device; and
wherein motion sensor senses a tilt angle of the portable device.

5. The portable device of claim 4, wherein the pendulum is curved.

6. The portable device of claim 5, wherein the pendulum is a permanent magnet.
